(19) United States
(12) Patent Application Publication
(10) Pub. No.: US 2014/0299535 A1
(43) Pub. Date: Oct. 9, 2014

(54) CONTACT FILTER DEVICE FOR SEPARATING SUSPENDED MATTER FROM WATER

(71) Applicant: Holger Blum, Teufen (CH)

(72) Inventor: Holger Blum, Teufen (CH)

(21) Appl. No.: 14/240,345

(22) PCT Filed: Aug. 22, 2012
(86) PCT No.: PCT/EP2012/066322

§ 371 Date: Apr. 10, 2014

(30) Foreign Application Priority Data
Aug. 23, 2011 (DE) 202011051065.4

(51) Int. Cl. B01D 29/00

(52) U.S. Cl. CPC B01D 29/00
USPC 210/435

(57) ABSTRACT

The invention relates to a contact filter device for filtering untreated water (R) and delivering clean water (P), with a rectangular filter box (1) in which an admission duct (7) is arranged on a wall of the filter box (1), and in which a bundle of catalyst tubes (30) is provided between the admission duct (7) and a side of the filter box (1) lying opposite the admission duct (7). The width of the admission duct (7) is approximately equal to the width of the filter box (1), and the depth of the admission duct (7) is a fraction of the width of the filter box (1), and the admission duct (7) has, at its upper area, an admission stub (13) for the untreated water (R) and, at the bottom, is open towards the interior of the filter box (1).

### BACKGROUND

1. Field

The invention relates to a contact filter device for separating suspended floating matter, sludge particles and solid matter particles from water.

2. Related Arts

Contact filter devices are already known, for example from U.S. Pat. No. 3,886,064, U.S. Pat. No. 4,151,084, U.S. Pat. No. 4,889,624, WO86/05412 and WO94/411312. All these devices have the disadvantage that they are poorly to be cleaned and maintained and that they can only separate suspended solid matter which is heavier than water. Also the efficiency in separating the solid matter hardly exceeds 85 to 90 percent.

### SUMMARY

It is an object of the invention to provide a contact filter device with a higher efficiency which is also able to separate suspended matter which is lighter than water.

For this purpose, the inventive contact filter device for filtering of untreated water and delivering clean water comprises a rectangular filter box in which an admission duct is arranged on a wall of the filter box, and in which a contact tube bundle is provided between the admission duct and a side of the filter box laying opposite to the admission duct, wherein the widths of the admission duct is approximately equal to the widths of the filter box, and the depth of the admission duct is a fraction of the widths of the filter box, and the admission duct has, at its upper area, an admission stub for the untreated water and, at the bottom, is open towards the interior of the filter box. Preferably, the admission duct is also open at its top.

The inventive contact filter device can separate suspended matter which is lighter than water, and an efficiency of the separation of more than 96 percent can be achieved in the contact filter device. Besides suspended matter and matter which are heavier than water, also living microorganisms of the output of biological cleaning stages can be separated from water by the inventive contact filter device. By means of the presence of the admission duct which hydraulically homogenizes the input of the water to be treated, the separation efficiency of the contact filter device is maximized.

An advantageous embodiment of the inventive contact filter device is characterized in that the filter box comprises a plane filter bottom and, subsequently thereto, four equally high side walls, a north side, a south side, an east side and a west side, wherein, in particular, also the admission duct has the shape of a rectangular box which is formed out of four equally high side walls, a north side, a south side, an east side and a west side. Thereby, a structure of the contact filter device clearly arranged and easily to produce, is resulting.

A further advantageous embodiment of the inventive contact filter device is characterized in that the relationship of the breadth of the south side of the filter box to the breadth of the south side of the admission duct amounts to approximately 5 to 15, whereby the hydraulic homogenization of the water stream to be cleaned, is improved.

A further advantageous embodiment of the inventive contact filter device is characterized in that the admission duct mounted in the filter box is removably mounted on the filter box such that it may be preferably taken out upwards from the filter box whereby, in an advantageous way, the cleaning of the contact filter device is facilitated.

A further advantageous embodiment of the inventive contact filter device is characterized in that the admission duct mounted to the filter box, overtops the filter box by at least one breadth of the south side of the admission duct, whereby, in an advantageous way, an easy mounting and demounting of the admission duct is ensured and, furthermore, the input stub may be placed at a position in the admission duct which is advantageous in view of process technology.

A further advantageous embodiment of the inventive contact filter device is characterized in that the filter box comprises an inclined discharge weir for floating sludge whereby the discharge weir preferably is arranged in form of an inclined rectangular plate having a horizontal weir edge as well as two side plates. Through the discharge weir, the floating sludge which is forming on the surface of the water, may be discharged, in an advantageous way, in a simple and efficient way for example to a waste removal container.

A further advantageous embodiment of the inventive contact filter device is characterized in that the discharge weir is arranged at a U-shaped, rectangular cut-out from the upper edge of the south side of the filter box, and that the breadth of the discharge weir approximately corresponds to the difference in length between the breadth of the south side of the filter box minus the breadth of the south side of the admission duct.

A further advantageous embodiment of the inventive contact filter device is characterized in that, in at least one side wall next to the transition to the filter bottom, a discharge stub is inserted for sludge sediment which stub is hydraulically connected to a sludge discharge valve, preferably a flap or ball valve. In advantageous way, it is possible thereby to discharge the sludge sediment deposited at the filter bottom easily from the contact filter device by temporarily, quickly opening the sludge discharge valve.

A further advantageous embodiment of the inventive contact filter device is characterized in that a collector for purified water in the shape of a vertically mounted tube piece being open at the top and at the bottom which is immersed by half into the water level forming at the top of the filter box with a horizontal level line A-A, and that a horizontally mounted clear water conduit is inserted into the collector which clear water conduit leads out of the contact filter device and, preferably, is shut off by a valve. By means of this arrangement, the clear water may be discharged in an advantageous way from the contact filter device while circumventing the floating sludge.

A further advantageous embodiment of the inventive contact filter device is characterized in that the contact tube bundle which is preferably implemented as a construction unit, comprises a plurality of equally long, vertical tube elements out of metal or plastics mounted in an honeycombed way close to each other, the upper ends and lower ends thereof being open, wherein, preferably, the opening diameter of the upper end and the lower end corresponds approximately to the tube diameter minus two times the wall thickness of the tube elements. By means of these contact tube bundle, a high efficiency in separating solid matter is achieved in an advantageous way.

A further advantageous embodiment of the inventive contact filter device is characterized in that the tube element has a shell surface (34) being formed ripped or as a perforated structure or as net structure, wherein a perforated structure is preferred. Thereby, the efficiency of the separation of solid matter is further put up in an advantageous way, in particular when the texturing of the shell surface is implemented such that a wetted surface of 100 to 300 m² per cubic meter contact tube bundle is available.

A further advantageous embodiment of the inventive contact filter device is characterized in that the rectangular filter box is provided with reinforcement rips provided on the outside, whereby, in an advantageous way, a material saving light construction of the contact filter device is made possible while maintaining the required stability of the filter box.

Further advantages, features and potential applications of the present invention may be gathered from the sub-claims.

### BRIEF DESCRIPTION OF THE DRAWINGS

Throughout the description, the claims and the drawings, those terms and associated reference signs will be used as are notable from the enclosed list of reference signs. In the drawings:

FIG. 1 is a section view of the inventive contact filter device, and

FIG. 2 is a side view of the inventive contact filter device.

### DETAILED DESCRIPTION

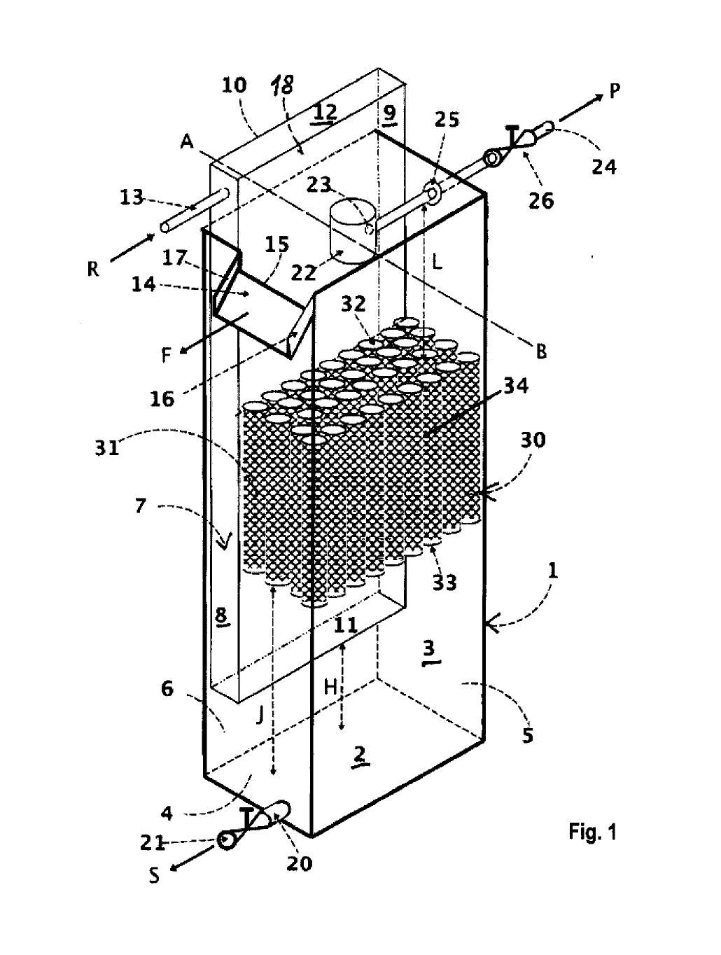

The inventive device in FIG. 1 comprises a rectangular filter box 1 which is open at the top, preferably a sheet metal construction, with a plane filter bottom 2 and subsequently thereto four equally high side walls, a north side 3, a south side 4, an east side 5 and a west side 6. An admission duct 7 is present in the device.

The admission duct 7 has the shape of a rectangular sheet metal box which is open at the top and at the bottom and formed out of four equally high side walls, a south side 8, a north side 9, a west side 10, an east side 18 as well as an upper opening 12 and a lower opening 11. The admission duct 7 is mounted in the filter box 1 such that the west side 10 of the admission duct lies against the west side 6 of the filter box 1.

The relationship of the breadth of the south side 4 of the filter box 1 to the breadth of the south side 8 of the admission duct amounts to about 5 to 15

$$\frac{breadth of south side 4 of filter box 1}{breadth of south side 8 of admission duct 7} = approximately 5 to 15$$

The north side 3 of the filter box 1 has the same breadth as the south side 4 of the filter box 1. The north side 9 of the admission duct has the same breadth as the south side 8 of the admission duct.

The relationship between the breadth of the south side 4 of the filter box 1 to the distance H of the admission duct 7 from the filter bottom 2 amounts approximately to 1 to 3

$$\frac{breadth of south side 4 of filter box 1}{distance H} = approximately 1 to 3$$

The admission duct 7 comprises an inlet stub 13 for untreated water. The input stub 13 opens, as shown in FIG. 1, into the south side 8 or the north side 9 or the west side 10 of the admission duct 7.

As mounted in the filter box 1, the admission duct 7 surmounts the same by at least a breadth of the south side 8 of the admission duct 7 whereby an easy mounting and demounting of the admission duct is ensured and, furthermore, the inlet stub 13 can be arranged at a position at the admission duct 7 which is advantageous in view of process technology. The admission duct 7 can also be simply pulled off upwards from the filter box 1 such that the cleaning of the same can be carried out in an easy way.

The filter box 1 has an inclined discharge weir 14 for floating sludge. The discharge weir 14 in the shape of an inclined, rectangular plate comprises a horizontal weir edge 15 as well as two side plates 16 and 17. As shown in FIG. 1, the discharge weir 14 is welded to a U-shaped, rectangular cut-out from the upper edge of the south side 4 of the filter box 1. The breadth of the discharge weir 14 corresponds approximately to the different in length between the breadth of the south side 4 of the filter box 1 minus the breadth of the south side 8 of the admission duct 7.

As experiments have shown, the inventive contact filter device comprises an optimized separation efficiency if the relationship of the length is:

$$\frac{breadth of south side 7 of admission duct 7}{height of the side plate 16 or 17} = approximately 1 to 3$$

A discharge stub 20 for sludge sediment is inserted into at least one of the side walls 3, 4, 5 or 6 of the filter box 1 near to the transition to the filter bottom 2. The discharge stub 20 is hydraulically connected to the sludge discharge valve 21. The sludge discharge valve 21 is in the shape of a flap or ball valve so that the sludge sediment as deposited on the filter bottom 2, can be discharged from the contact filter device by temporarily, quickly opening of 21.

The contact filter device comprises, furthermore, a collector 22 for purified water. The collector 22 has the shape of a vertically mounted tube piece which is open at the top and at the bottom and which is submerged by half into the water level being formed at the top in the filter box 1 with the horizontal level line A-B.

As is shown in FIG. 1, the collector 22 comprises, at half the tube length, a lateral welding perforation 23 into which a horizontally mounted clear water line 24 is inserted. The clear water line leads out of the inventive contact filter device through the discharge stub 25 and can be shut off by means of the valve 26.

As explained in FIG. 1, the position of the discharge flange in the north side 3 of the filter box 1 defines the height of the level line A-B of the water level therein. For the functionality of the inventive device to be ensured, the level line A-B has to be defined such that it lies some centimeters below the horizontal weir edge 15.

Further, a rectangular shaped contact tube bundle 30 is arranged in the filter box 1. The contact tube bundle 30 comprises a plurality of equally long, vertical and honeycombed shaped tube elements 31 out of metal or plastics mounted next to each other, the upper ends 32 and the lower ends 33 thereof being open. Preferably, the opening diameter of 32 and 33 corresponds to the tube diameter minus two times the wall thickness of the tube elements 31.

Furthermore, the shell surface 34 of the tube element 31 is arranged to be textured, ripped or as perforated net. As experiments have shown, the contact filter device shows an optimized separation efficiency when the texturing of the shell surface 34 is implemented such that a wetted surface of 100 to 300 m² is available per cubic meter of contact tube bundle. The length of the contact tube bundle 30 corresponds to the interior breadth of the east side 5 of the filter box 1. The breadth of the contact tube bundle 30 corresponds approximately to the length difference between the breadth of the south side 4 of the filter box 1 minus the breadth of the south side 8 of the admission duct 7.

As experiments have shown, the contact filter device comprises an improved separation efficiency if the distance J of the contact tube bundle 30 from the filter bottom 2 as measured from the lower end 33 of a tube element 31 on mounting in the filter box is chosen such that:

J=1×H to 3×H

is true.

The height of the contact tube bundle 30 amounts to 1 to 3 meters, and tube elements 31 if they are shorter than 1 to 3 meters, are arranged vertically on top of each other if necessary.

As experiments have shown, the contact filter device comprises an optimized separation efficiency if the distance L of the clear water line 24 from the contact tube bundle 30 is measured from the upper end 32 of the tube element 31, is structurally dimensioned in the filter box 1 such that:

L=1×H to 3×H

is true.

The tube elements 31 of the contact tube bundle are completely accessible on the top thereof such that an eventual cleaning process can be carried out easily.

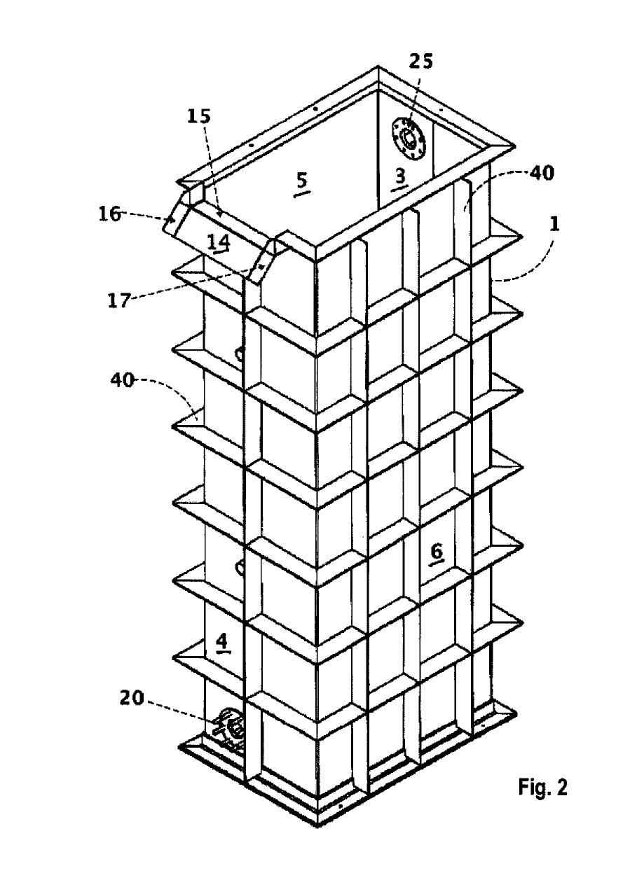

As can be seen from FIG. 2, the steel sheet construction of the rectangular filter box 1 which is open at the top is provided with external reinforcement rips 40 also out of sheet material, wherefrom a material saving light construction for the contact filter device is resulting.

### Separation Operation

The untreated water 3 which is contaminated by suspended floating matter, sludge particles and solid state particles, enters into the admission duct 7 through the input stub 13 and continuously flows downwards to the filter bottom 2 where sludge materials which are heavier than water, are deposited.

The untreated water purified in this way, further-on flows vertically upwards and continuously enters the lower tube opening 33 of the tube elements 31 of the contact tube bundle 30.

Upon flowing through the contact tube bundle 30, the water is further cleaned of finest, floating materials and of living microorganisms.

The water purified in this way, exits on top from the upper tube openings 32 of the tube elements 31 of the contact tube bundle 30 and flows upwards to the collector 22. From the collector 22, the purified water P exits the inventive device through the opened valve 26 and through the clear water conduit 24.

### Removal of Deposited Sludge

From time to time, the deposited sludge L deposited on the filter bottom 2 is removed or discharged, respectively, from the inventive device by opening the valve 21. The inflow of the untreated water R to the inventive device is not interrupted during this sludge discharge operation.

### Discharge of Floating Sludge

Certain residual amounts of suspended floating materials, sludge particles and solid state particles may collect on the water level with the level line A-B above the contact tube bundle 30, and they form a layer of floating sludge F there. For the removal of the floating sludge F collected at the height of the level line A-B on the water, the shut-off valve 26 for clear water is closed during running input of untreated water R to the inventive device.

By means of this measure, the water in the contact filter device is accumulated, and as a consequence, the height of the level line A-B slowly increases until the water level reaches the height of the weir edge 15 and the floating sludge F flows through the discharge weir for floating sludge 14 out of the inventive contact filter device.

### EXAMPLE

The output of an aerobic, biological clarification plant for commercial untreated water and constructed according to WO2010145810 (method and device for purifying untreated water), was introduced into the inventive contact filter device as untreated water stream R.

The dwelling time of the untreated water to be cleaned, in the contact filter device amounted to about 80 to 160 minutes.

After each 72 hours, the deposited sludge as deposited at the filter bottom 2 was discharged through the discharge stub 20 together with about 9 volume percent of the total water amount present in the contact filter device by opening the valve 21.

As a result, the cleared discharge stream B of about 1 m³h which exited the inventive contact filter device via the clear water conduit 24, constantly shows only a content of unfilterable materials (ATV Rules No. 2-2) of less than 20 milligrams per liter which corresponds to a efficiency of the separation of 99 percent.

### List of Reference Signs

1 filter box
2 filter bottom
3 north side of filter box
4 south side of filter box
5 east side of filter box
6 west side of filter box
7 admission duct
8 south side of admission duct
9 north side of admission duct
10 west side of admission duct
11 lower opening of admission duct
12 upper opening of admission duct
13 input stub for untreated water
14 discharge weir for floating sludge
15 weir edge
16 side plate
17 side plate
18 east side of admission duct
20 discharge duct for deposited sludge
21 sludge discharge valve
22 collector for clear water
23 weld perforation of collector
24 clear water conduit
25 discharge flange
26 shut-off valve
30 contact tube bundle
31 tube element
32 upper tube opening
33 lower tube opening
34 tube shell
40 reinforcement rips
A-B level line of liquid
F floating sludge
H distance from admission duct 7 to filter bottom 2
J distance from contact tube bundle 30 to filter bottom 2
L distance from contact tube bundle 30 to the clear water conduit 24
P clear water
R untreated water
S deposited sludge

1. Contact filter device for filtering of untreated water and delivering clear water having:
a rectangular filter box in which an admission duct is arranged on a wall of the filter box and in which a contact tube bundle is provided between the admission duct; and
a side of the filter box lying opposite to the admission duct;
wherein the width of the admission duct is approximately equal to the width of the filter box; wherein
the depth of the admission duct is a fraction of the width of the filter box; and wherein the admission duct has, at its upper area, an admission stub for the untreated water and, at the bottom, is open towards the interior of the filter box.

2. Contact filter device according to claim 1, wherein the filter box comprises a plane filter bottom, and subsequently thereto four equally high side walls, a north side, a south side, an east side and a west side.

3. Contact filter device according to claim 1, wherein the admission duct is open at the top.

4. Contact filter device according to claim 1, wherein the admission duct has a shape of a rectangular box formed out of four equally high side walls, a north side, a south side, an east side and a west side.

5. Contact filter device according to claim 2, wherein the admission duct is mounted in the filter box such that the west side of the admission duct lies on the west side of the filter box.

6. Contact filter device according to claim 2, wherein the relationship of the breadth of the south side of the filter box to the breadth of the south side of the admission duct amounts to about 5 to 15.

7. Contact filter device according to claim 2, wherein the north side of the filter box comprises the same breadth as the south side of the filter box, and wherein the north side of the admission duct comprises the same breadth as the south side of the admission duct.

8. Contact filter device according to claim 2, wherein the relationship of the breadth of the south side of the filter to the distance of the admission duct from the filter bottom amounts to about 1 to 3.

9. Contact filter device according to claim 1, wherein the admission duct mounted in the filter box is removably mounted to the filter box such that, it can be taken off upwards from the filter box.

10. Contact filter device according to claim 1, wherein the admission duct mounted in the filter box, overtops the same by at least the breadth of the south side of the admission duct.

11. Contact filter device according to claim 1, wherein the filter box comprises an inclined discharge weir for floating sludge, wherein the discharge weir is implanted in the shape of an inclined, rectangular plate with a horizontal weir edge as well as two side plates.

12. Contact filter device according to claim 11, wherein the discharge weir is arranged at a U-shaped, rectangular cut-out at the upper edge of the south side of the filter box, and wherein the breadth of the discharge weir corresponds approximately to the length difference between the breadth of the south side of the filter box minus the breadth of the south side of the admission duct.

13. Contact filter device according to claim 1, wherein, in at least one side wall next to the transition to the filter bottom, a discharge stub for deposited sludge is inserted which is hydraulically connected to a sludge discharge valve.

14. Contact filter device according to claim 1, wherein a collector for clean water in the shape of a vertically mounted tube piece which is open at the top and at the bottom, which tube piece is submerged by half into the water level formed at the top in the filter box, and wherein a horizontally mounted clean water conduit is inserted into the collector which leads out of the contact filter device and, is adapted to be shut-off by a valve.

15. Contact filter device according to claim 1, wherein the contact tube bundle comprises a plurality of equally long, vertical and honeycomb shaped tube elements out of metal or plastic which are mounted next to each other, the upper end and lower end thereof being opened.

16. Contact filter device according to claim 15, wherein the tube element has a textured, for example waved, ripped or perforated structure or net structure implemented shell surface.

17. (canceled)

18. Contact filter device according to claim 15, wherein the length of the contact tube bundle corresponds to the interior breadth of the east side of the filter box, and wherein the breadth of the contact tube bundle corresponds approximately to the length difference between the breadth of the south side of the filter box minus the breadth of the south side of the admission duct.

19. Contact filter device according to claim 15, wherein the distance of the contact tube bundle from the filter bottom as measured from the lower end of the tube element during mounting in the filter box is chosen such that
J=1×H to 3×H
is true.

20. (canceled)

21. Contact filter device according to claim 15, wherein the distance of the clear water conduit from the contact tube bundle as measured from the upper end of the tube element, is structurally dimensioned in the filter box such that
L=1×H to 3×H
is true.

22. Contact filter device according to claim 1, wherein the rectangular filter box is provided with reinforcement rips fixed to an outside thereof.
